(19) United States
(12) Patent Application Publication
(10) Pub. No.: US 2017/0238715 A1
(43) Pub. Date: Aug. 24, 2017

(54) BED AND BED FRAME HAVING SUPPORTING BARS COUPLED BY TOUCH FASTENERS

(71) Applicant: Inno-Sports Co., Ltd., Xiamen (CN)

(72) Inventor: Kwan Jun Choi, Xiamen (CN)

(21) Appl. No.: 15/440,989

(22) Filed: Feb. 23, 2017

(30) Foreign Application Priority Data
Feb. 23, 2016 (CN) 201620134783.7

(51) Int. Cl. A47C 19/02; F16B 12/54; A47C 19/00

(52) U.S. Cl. CPC A47C 19/025; A47C 19/005; F16B 12/54

(57) ABSTRACT

A bed frame includes a peripheral frame and a plurality of supporting bars coupled to the peripheral frame by first and second touch fasteners. Each of the first and second touch fasteners includes a first component and a second component configured to detachably engage with each other. The first components of the first and second touch fasteners are disposed at the peripheral frame. The first and second ends of the supporting bars are coupled to the second components of the first and second touch fasteners. By engaging the first and second components of the first and second touch fasteners, the plurality of supporting bars are securely coupled to the peripheral frame.

### CROSS-REFERENCE TO RELATED APPLICATIONS

The present application claims priority to Chinese Utility Model Applications CN 201620134783.7 filed Feb. 23, 2016. The disclosure of the application is incorporated herein for all purposes by reference in its entirety.

### FIELD OF THE INVENTION

The present invention generally relates to beds and bed frames, and more particularly, relates to bed frames having supporting bars coupled by touch fasteners and beds having such bed frames.

### BACKGROUND

There are various different types of beds in the market. One of them includes a bed frame composed of a peripheral frame and a plurality of supporting slats. In some cases, the supporting slats are separate and independent from the peripheral frame and from each other. As such, to assemble the bed frame, each supporting slat needs to be individually fastened to the peripheral frame; and to disassemble the bed frame, each supporting slat needs to be individually decoupled from the peripheral frame. This is time-consuming and inconvenient. In addition, separated supporting slats are inconvenient to store and transport. In some other cases, the supporting slats are preassembled by being fixedly coupled to an outer frame, which is configured to be placed on the peripheral frame. Although such a bed frame is easy to assemble and disassemble, it increases the manufacturing cost and requires a relative larger space for storage and transportation.

Given the current state of the art, there remains a need for beds and bed frames that address the abovementioned issues.

The information disclosed in this Background section is provided for an understanding of the general background of the invention and is not an acknowledgement or suggestion that this information forms part of the prior art already known to a person skilled in the art.

### SUMMARY OF THE INVENTION

The present invention provides beds and bed frames that are easy to assemble and disassemble, and convenient for storage and transportation.

In various exemplary embodiments, the present invention provides a bed frame including a peripheral frame and a plurality of supporting bars configured to be coupled to the peripheral frame by tough fasteners. The peripheral frame includes a first peripheral lateral bar, a second peripheral lateral bar, a first peripheral longitudinal bar, and a second peripheral longitudinal bar. Each respective end of the first or second peripheral lateral bar is configured to be connected to a corresponding end of the first or second peripheral longitudinal bar. Each supporting bar in the plurality of supporting bars includes a first end and a second end. The touch fasteners include a first touch fastener and a second touch fastener, each including a first component and a second component configured to detachably engage with each other. The first component of the first touch fastener is configured to be coupled to the first peripheral longitudinal bar along a longitudinal direction of the first peripheral longitudinal bar. The first component of the second touch fastener is configured to be coupled to the second peripheral longitudinal bar along a longitudinal direction of the second peripheral longitudinal bar. The first ends of the plurality of supporting bars are configured to be coupled to the second component of the first touch fastener along a length of the second component of the first touch fastener. The second ends of the plurality of supporting bars are configured to be coupled to the second component of the second touch fastener along a length of the second component of the second touch fastener. Engaging the first and second components of the first touch fastener securely couples the first ends of the plurality of supporting bars to the first peripheral longitudinal bar, and engaging the first and second components of the second touch fastener securely couples the second ends of the plurality of supporting bars to the second peripheral longitudinal bar.

In some exemplary embodiments, at least one of the first and second touch fasteners is a hook-loop fastener. In an exemplary embodiment, at least one of the first and second touch fasteners is a Velcro® fastener or a Velcro® tape. In an exemplary embodiment, at least one of the first and second touch fasteners is in a form of an elongated strip.

In some exemplary embodiments, the first ends of the plurality of supporting bars are arranged at substantially equal distance intervals along a length of the second component of the first touch fastener, and the second ends of the plurality of supporting bars are arranged at substantially equal distance intervals along a length of the second component of the second touch fastener. In an exemplary embodiment, when assembled, the first and second peripheral longitudinal bars are substantially parallel to each other. In an exemplary embodiment, when assembled, the first and second peripheral lateral bars are substantially parallel to each other. In an exemplary embodiment, when assembled, the first peripheral lateral bar, the second peripheral lateral bar, and the plurality of supporting bars are substantially parallel to each other.

In an exemplary embodiment, each supporting bar in the plurality of supporting bars is a slat.

In some exemplary embodiments, each of the first and second peripheral longitudinal bars includes a supporting portion extending along the longitudinal direction thereof, wherein the supporting portion has a supporting surface facing upwardly when the bed frame is assembled. Each supporting bar in the plurality of supporting bars includes an attaching surface facing downwardly when the bed frame is assembled. The first component of the first touch fastener is disposed on the supporting surface of the supporting portion of the first peripheral longitudinal bar, and fixedly coupled to the supporting portion of the first peripheral longitudinal bar. The first component of the second touch fastener is disposed on the supporting surface of the supporting portion of the second peripheral longitudinal bar, and fixedly coupled to the supporting portion of the second peripheral longitudinal bar. The attaching surface of each supporting bar at the first end is coupled to the second component of the first touch fastener. The attaching surface of each supporting bar at the second end is coupled to the second component of the second touch fastener.

In some exemplary embodiments, the first component of the first touch fastener is fixedly coupled to the supporting portion of the first peripheral longitudinal bar by one or more of a nail, a screw and a bolt. In an exemplary embodiment, the supporting portion of the first peripheral longitudinal bar includes one or more holes at the supporting surface, each hole in the one or more holes configured to accommodate a nail, a screw or a bolt for securing the first component of the first touch fastener on the supporting surface. In some exemplary embodiments, the first component of the second touch fastener is fixedly coupled to the supporting portion of the second peripheral longitudinal bar by one or more of a nail, a screw and a bolt. In an exemplary embodiment, the supporting portion of the second peripheral longitudinal bar includes one or more holes at the supporting surface, each hole in the one or more holes configured to accommodate a nail, a screw or a bolt for securing the first component of the second touch fasteners on the supporting surface.

In some exemplary embodiments, the bed frame further includes an interior longitudinal bar configured to be disposed inside of the peripheral frame, wherein when assembled, the interior longitudinal bar has a first end connected to the first peripheral lateral bar, a second end connected to the second peripheral lateral bar, and a supporting surface facing upwardly. In an exemplary embodiment, the first end of the interior longitudinal bar includes a connecting piece configured to be coupled to the first peripheral lateral bar by one or more of a nail, a screw and a bolt. In an exemplary embodiment, the second end of the interior longitudinal bar includes a connecting piece configured to be coupled to the second peripheral lateral bar by one or more of a nail, a screw and a bolt.

In some exemplary embodiments, the bed frame further includes a third touch fastener including a first component and a second component configured to detachably engage with each other. The first component of the third touch fastener is disposed on the supporting surface of the interior longitudinal bar and coupled to the interior longitudinal bar. The attaching surface of each supporting bar at a middle portion between the first and second ends is coupled to the second component of the third touch fastener. In an exemplary embodiment, the third touch fastener is a hook-loop fastener, a Velcro® fastener or a Velcro® tape.

In some exemplary embodiments, the bed frame further includes a plurality of legs, each disposed below the peripheral frame and connected to peripheral frame when the bed frame is assembled.

In various exemplary embodiments, the present invention provides a bed including a bed frame of the present invention.

The beds and bed frames of the present invention have other features and advantages that will be apparent from, or are set forth in more detail in, the accompanying drawings, which are incorporated herein, and the following Detailed Description, which together serve to explain certain principles of exemplary embodiments of the present invention.

### BRIEF DESCRIPTION OF THE DRAWINGS

The accompanying drawings, which are incorporated into and constitute a part of this specification, illustrate one or more exemplary embodiments of the present invention and, together with the Detailed Description, serve to explain the principles and implementations of exemplary embodiments of the invention.

FIG. 1 is a perspective view illustrating an assembled bed frame in accordance with some exemplary embodiments of the present invention.

FIG. 2 is a perspective view illustrating a partially assembled bed frame in accordance with some exemplary embodiments of the present invention.

FIG. 3 is a cutout side view illustrating an exemplary engagement of supporting bars with the peripheral frame in accordance with some exemplary embodiments of the present invention.

### DETAILED DESCRIPTION

Reference will now be made in detail to implementations of exemplary embodiments of the present invention as illustrated in the accompanying drawings. The same reference indicators will be used throughout the drawings and the following detailed description to refer to the same or like parts. Those of ordinary skill in the art will understand that the following detailed description is illustrative only and is not intended to be in any way limiting. Other embodiments of the present invention will readily suggest themselves to such skilled persons having benefit of this disclosure.

In the interest of clarity, not all of the routine features of the implementations described herein are shown and described. It will be appreciated that, in the development of any such actual implementation, numerous implementation-specific decisions are made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Many modifications and variations of the exemplary embodiments set forth in this disclosure can be made without departing from the spirit and scope of the embodiments, as will be apparent to those skilled in the art. The specific exemplary embodiments described herein are offered by way of example only.

Embodiments of the present invention are described in the context of bed frames and beds including the bed frames. In general, a bed frame of the present invention includes a peripheral frame and a plurality of supporting bars. The plurality of supporting bars is configured to be coupled to the peripheral frame by touch fasteners. As such, the bed frames of the present invention are easy to assemble and disassemble, and thus convenient to end users. In various embodiments, the supporting bars are also coupled to each other through one or more touch fasteners or through a component of the one or more touch fasteners. As such, the plurality of supporting bars can be rolled, furled, or bundled together easily and tightly, making storage and transportation of the bed frame easy and convenient.

The beds and bed frames of the present invention can be of various sizes including but not limited to twin, full, queen and king sizes, and of various shapes including but not limited to rectangles and squares. They can be made of various materials including, but not limited to, metals such as steel, plastics and woods.

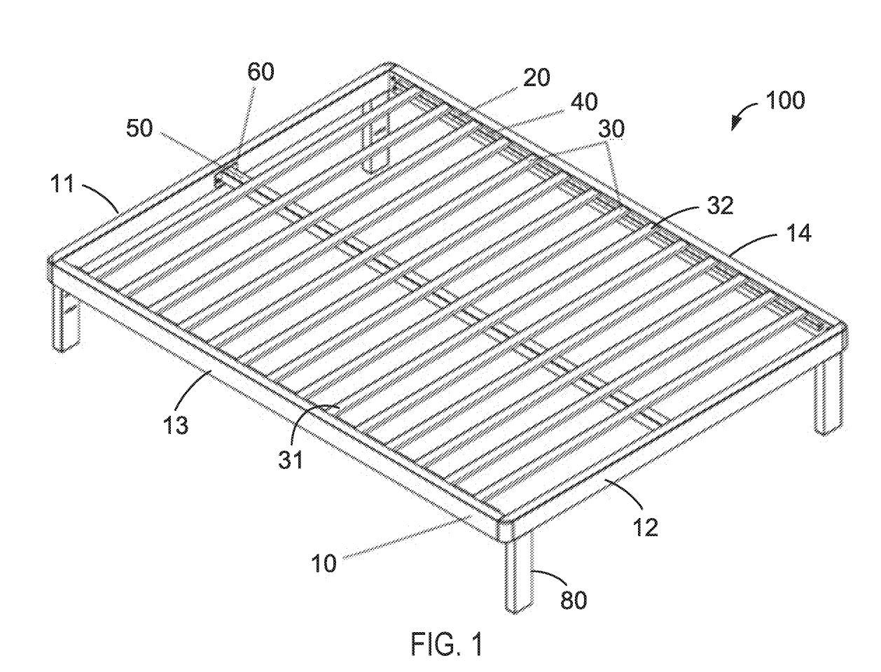

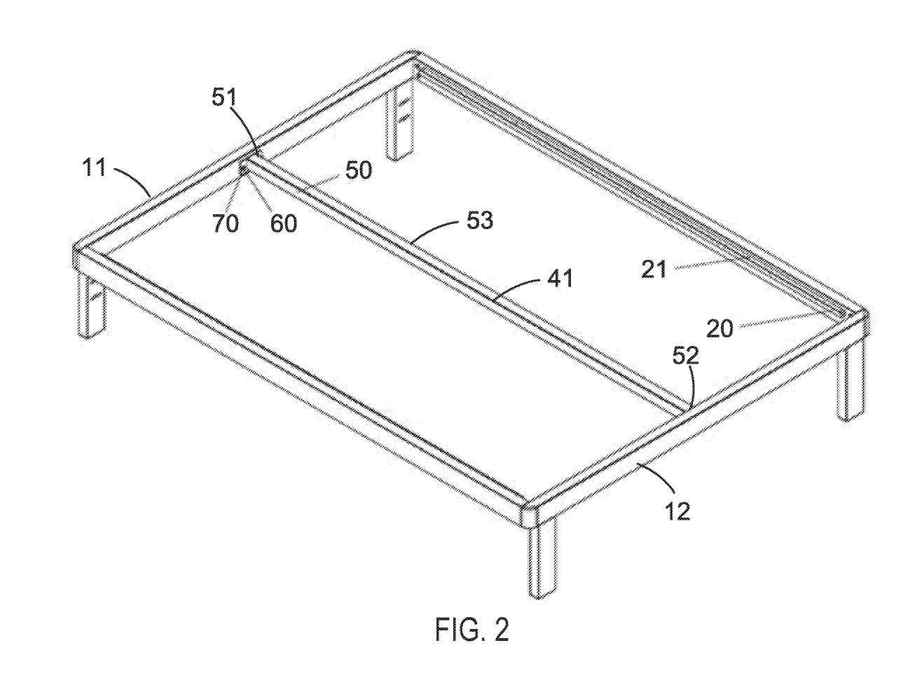

Referring now to FIGS. 1 and 2, there is depicted an exemplary bed frame in accordance with some exemplary embodiments of the present invention. As show, bed frame 100 includes peripheral frame 10 and a plurality of supporting bars 30 configured to be coupled to the peripheral frame. Peripheral frame 10 includes first peripheral lateral bar 11, second peripheral lateral bar 12, first peripheral longitudinal bar 13, and second peripheral longitudinal bar 14. When assembled, peripheral lateral and longitudinal bars are connected to each other at their respective ends. For instance, first peripheral lateral bar 11 has one end connected to an end of first peripheral longitudinal bar 13, and the other end connected to an end of second peripheral longitudinal bar 14. In an exemplary embodiment, when assembled, first peripheral lateral bar 11 and second peripheral lateral bar 12 are substantially parallel to each other. In an exemplary embodiment, when assembled, first peripheral longitudinal bar 13 and second peripheral longitudinal bar 14 are substantially parallel to each other.

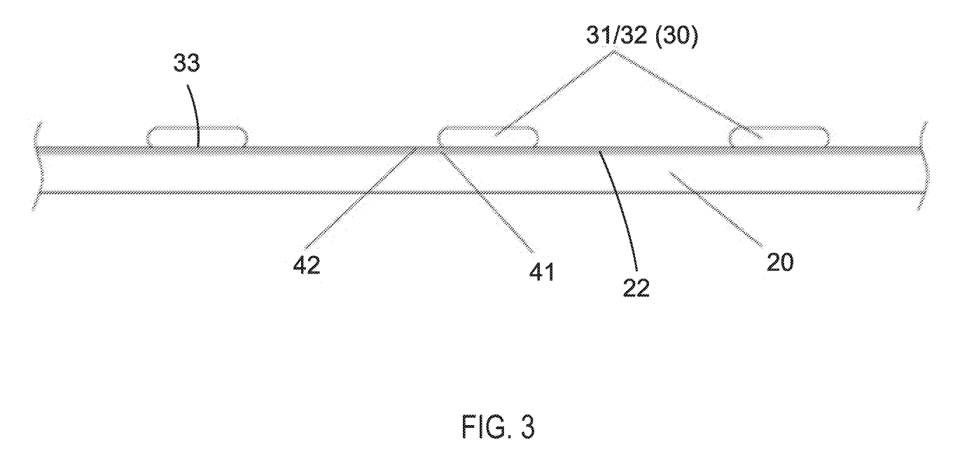

In some exemplary embodiments, each supporting bar 30 in the plurality of supporting bars has first end 31 and second end 32. To accommodate the first and second ends of the supporting bars, each of the first and second peripheral longitudinal bars includes a supporting portion such as supporting portion 20 extending along the longitudinal direction of the first or second peripheral longitudinal bar, respectively. The supporting portion has a supporting surface such as supporting surface 22 illustrated in FIG. 3. When the bed frame is assembled, supporting surface 22 faces upwardly. The first ends of the supporting bars are placed above the supporting surface of the supporting portion of the first peripheral longitudinal bar. The second ends of the supporting bars are placed above the supporting surface of the supporting portion of the second peripheral longitudinal bar.

In various exemplary embodiments, the plurality of supporting bars is coupled to the peripheral frame by one or more touch fasteners 40. For instance, in some exemplary embodiments, first ends 31 of the supporting bars are coupled with supporting portion 20 of first peripheral longitudinal bar 13 by a first touch fastener, and second ends 32 of the supporting bars are coupled with supporting portion 20 of second peripheral longitudinal bar 14 by a second touch fastener.

As used herein, a touch fastener refers to a fastener constituted of two components, the opposing surfaces of which can be detachably fastened or bound to each other, for instance by pressing the two components together. The two components can be separated by pulling or peeling them apart. By way of example, FIG. 3 illustrates touch fastener 40 including first component 41 and second component 42. In some exemplary embodiments, touch fastener 40 is a hook and loop fastener. In an exemplary embodiment, touch fastener 40 is a Velcro® fastener or a Velcro® tape. In some exemplary embodiments, touch fastener 40 is in a form of an elongated strip.

It should be noted that any one of the first and second components can be a hook or a loop or the like, as long as the first and second components match to each other and can be detachably fastened to each other. It should also be noted that touch fasteners used in one bed frame can be the same or different from each other in terms of their types, sizes, shapes, arrangements, or the like.

In some exemplary embodiments, the first component of the first touch fastener is coupled to the first peripheral longitudinal bar along a longitudinal direction of the first peripheral longitudinal bar. The first component of the second touch fastener is coupled to the second peripheral longitudinal bar along a longitudinal direction of the second peripheral longitudinal bar. The first ends of the plurality of supporting bars are coupled to the second component of the first touch fastener along a length of the second component of the first touch fastener. The second ends of the plurality of supporting bars are coupled to the second component of the second touch fastener along a length of the second component of the second touch fastener. As such, the first ends of the plurality of supporting bars can be coupled to the first peripheral longitudinal bar through engagement of the first and second components of the first touch fastener; and the second ends of the plurality of supporting bars are coupled to the second peripheral longitudinal bar through engagement of the first and second components of the second touch fastener.

Referring to FIGS. 2 and 3, in some exemplary embodiments, first component 41 of the first touch fastener is disposed on supporting surface 22 of supporting portion 20 of the first peripheral longitudinal bar, and fixedly coupled to the supporting portion of the first peripheral longitudinal bar, for example, by an adhesive, a nail, a screw, a bolt, or the like, or any combination thereof. Similarly, first component 41 of the second touch fastener is disposed on supporting surface 22 of supporting portion 20 of the second peripheral longitudinal bar, and fixedly coupled to the supporting portion of the second peripheral longitudinal bar, for example, by an adhesive, a nail, a screw, a bolt, or the like, or any combination thereof. In an exemplary embodiment, supporting portion 20 of the first or second peripheral longitudinal bar includes one or more holes such as hole 21 at the supporting surface; each hole 21 in the one or more holes is configured to accommodate a nail, a screw, a bolt or the like for securing the first component of the first or second touch fastener on the supporting surface.

In some exemplary embodiments, each supporting bar in the plurality of supporting bars is a slat, made of wood, plastic, metal, or the like. In an exemplary embodiment, each supporting bar in the plurality of supporting bars includes an attaching surface such as attaching surface 33, which faces downwardly when the bed frame is assembled. Attaching surface 33 of each supporting bar at the first end is coupled to second component 42 of the first touch fastener, for example, by an adhesive, a nail, a screw, a bolt, or the like, or any combination thereof. Similarly, attaching surface 33 of each supporting bar at the second end is coupled to second component 42 of the second touch fastener, for example, by an adhesive, a nail, a screw, a bolt, or the like, or any combination thereof. As such, by engaging the first and second components of the first and second touch fasteners, the plurality of supporting bars are securely coupled to the peripheral frame.

In an exemplary embodiment, the first ends of the plurality of supporting bars are arranged at substantially equal distance intervals along a length of the second component of the first touch fastener. Similarly, the second ends of the plurality of supporting bars are arranged at substantially equal distance intervals along a length of the second component of the second touch fastener. In an exemplary embodiment, when assembled, first peripheral lateral bar 11, second peripheral lateral bar 12 and the plurality of supporting bars 30 are substantially parallel to each other.

In some exemplary embodiments, bed frame 100 further includes one or more interior longitudinal bars such as interior bar 50 configured to be disposed inside of the peripheral frame. Interior longitudinal bar 50 has first end 51, second end 52 and supporting surface 53. When assembled, first end 51 is connected to the first peripheral lateral bar and second end 52 is connected to the second peripheral lateral bar, with supporting surface 53 facing upwardly.

In an exemplary embodiment, first end 51 of the interior longitudinal bar includes a connecting piece such as connecting piece 60 configured to be coupled to first peripheral lateral bar 11, for example, by one or more of a nail, a screw, a bolt or the like. For instance, FIG. 2 illustrates connecting piece 60 is coupled to first peripheral lateral bar 11 by bolt 70 from one or more sides of first end 51 of the interior longitudinal bar. Similarly, second end 52 of the interior longitudinal bar includes a connecting piece such as connecting piece 60 configured to be coupled to second peripheral lateral bar 12, for example, by one or more of a nail, a screw, a bolt or the like.

In some exemplary embodiments, bed frame 100 further includes one more touch fasteners 40 to couple the plurality of supporting bars with the one or more interior longitudinal bars. For instance, in an exemplary embodiment, bed frame 100 further includes a third touch fastener with its first component 41 disposed on supporting surface 53 of interior longitudinal bar 50. Like the first and second fasteners, first component 41 of the third touch fastener can be coupled to the interior longitudinal bar, for example, by an adhesive, a nail, a screw, a bolt, or the like, or any combination thereof. In such embodiments, the attaching surface of each supporting bar at a corresponding middle portion between the first and second ends is coupled to the second component of the third touch fastener.

In various exemplary embodiments, the bed frame further includes a plurality of legs such as four legs 80. Each leg 80 is disposed below the peripheral frame and connected to peripheral frame when the bed frame is assembled.

As disclosed herein, the plurality of supporting bars is configured to be coupled to the peripheral frame by touch fasteners, making the assembling and disassembling of the beds and bed frames easy and convenient. The supporting bars are also coupled to each other by components of the touch fasteners and thus can be rolled, furled, or bundled together easily and tightly, making storage and transportation of the beds and bed frames easy and convenient.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that the terms “peripheral” or “interior”, and etc. are used to describe features of the exemplary embodiments with reference to the positions of such features as displayed in the figures. It will be understood that, although the terms “first,” “second,” etc. may be used herein to describe various elements, these elements should not be limited by these terms. These terms are only used to distinguish one element from another. For example, a first touch fastener could be termed a second touch fastener, and, similarly, a second touch fastener could be termed a first touch fastener, without changing the meaning of the description, so long as all occurrences of the “first touch fastener” are renamed consistently and all occurrences of the “second touch fastener” are renamed consistently.

What is claimed is:

1. A bed frame comprising:
a peripheral frame comprising a first peripheral lateral bar, a second peripheral lateral bar, a first peripheral longitudinal bar, and a second peripheral longitudinal bar, wherein each respective end of the first or second peripheral lateral bar is configured to be connected to a corresponding end of the first or second peripheral longitudinal bar;
a plurality of supporting bars, each comprising a first end and a second end; and
first and second touch fasteners, each comprising a first component and a second component configured to detachably engage with each other, wherein
the first component of the first touch fastener is configured to be coupled to the first peripheral longitudinal bar along a longitudinal direction of the first peripheral longitudinal bar;
the first component of the second touch fastener is configured to be coupled to the second peripheral longitudinal bar along a longitudinal direction of the second peripheral longitudinal bar;
the first ends of the plurality of supporting bars are configured to be coupled to the second component of the first touch fastener along a length of the second component of the first touch fastener; and
the second ends of the plurality of supporting bars are configured to be coupled to the second component of the second touch fastener along a length of the second component of the second touch fastener,
wherein engaging the first and second components of the first touch fastener securely couples the first ends of the plurality of supporting bars to the first peripheral longitudinal bar, and engaging the first and second components of the second touch fastener securely couples the second ends of the plurality of supporting bars to the second peripheral longitudinal bar.

2. The bed frame of claim 1, wherein at least one of the first and second touch fasteners is a hook-loop fastener.

3. The bed frame of claim 1, wherein at least one of the first and second touch fasteners is a Velcro® fastener or a Velcro® tape.

4. The bed frame of claim 1, wherein at least one of the first and second touch fasteners is in a form of an elongated strip.

5. The bed frame of claim 1, wherein:
the first ends of the plurality of supporting bars are arranged at substantially equal distance intervals along a length of the second component of the first touch fastener; and
the second ends of the plurality of supporting bars are arranged at substantially equal distance intervals along a length of the second component of the second touch fastener.

6. The bed frame of claim 1, wherein when assembled, the first and second peripheral longitudinal bars are substantially parallel to each other.

7. The bed frame of claim 1, wherein when assembled, the first and second peripheral lateral bars are substantially parallel to each other.

8. The bed frame of claim 1, wherein when assembled, the first peripheral lateral bar, the second peripheral lateral bar, and the plurality of supporting bars are substantially parallel to each other.

9. The bed frame of claim 1, further comprising a plurality of legs, each disposed below the peripheral frame and connected to peripheral frame when the bed frame is assembled.

10. The bed frame of claim 1, wherein:
each of the first and second peripheral longitudinal bars comprises a supporting portion extending along the longitudinal direction thereof, wherein the supporting portion has a supporting surface facing upwardly when the bed frame is assembled;
each supporting bar in the plurality of supporting bars comprises an attaching surface facing downwardly when the bed frame is assembled;
the first component of the first touch fastener is disposed on the supporting surface of the supporting portion of the first peripheral longitudinal bar, and fixedly coupled to the supporting portion of the first peripheral longitudinal bar;
the first component of the second touch fastener is disposed on the supporting surface of the supporting portion of the second peripheral longitudinal bar, and fixedly coupled to the supporting portion of the second peripheral longitudinal bar;
the attaching surface of each supporting bar at the first end is coupled to the second component of the first touch fastener; and
the attaching surface of each supporting bar at the second end is coupled to the second component of the second touch fastener.

11. The bed frame of claim 10, wherein the first component of the first touch fastener is fixedly coupled to the supporting portion of the first peripheral longitudinal bar by one or more of a nail, a screw and a bolt.

12. The bed frame of claim 10, wherein the first component of the second touch fastener is fixedly coupled to the supporting portion of the second peripheral longitudinal bar by one or more of a nail, a screw and a bolt.

13. The bed frame of claim 10, wherein the supporting portion of the first peripheral longitudinal bar comprises one or more holes at the supporting surface, each hole in the one or more holes configured to accommodate a nail, a screw or a bolt for securing the first component of the first touch fastener on the supporting surface.

14. The bed frame of claim 10, wherein the supporting portion of the second peripheral longitudinal bar comprises one or more holes at the supporting surface, each hole in the one or more holes configured to accommodate a nail, a screw or a bolt for securing the first component of the second touch fasteners on the supporting surface.

15. The bed frame of claim 10, wherein each supporting bar in the plurality of supporting bars is a slat.

16. The bed frame of claim 10, further comprising:
an interior longitudinal bar configured to be disposed inside of the peripheral frame, wherein when assembled, the interior longitudinal bar has a first end connected to the first peripheral lateral bar, a second end connected to the second peripheral lateral bar, and a supporting surface facing upwardly.

17. The bed frame of claim 16, wherein:
the first end of the interior longitudinal bar comprises a connecting piece configured to be coupled to the first peripheral lateral bar by one or more of a nail, a screw and a bolt; and
the second end of the interior longitudinal bar comprises a connecting piece configured to be coupled to the second peripheral lateral bar by one or more of a nail, a screw and a bolt.

18. The bed frame of claim 16, further comprising:
a third touch fastener comprising a first component and a second component configured to detachably engage with each other, wherein
the first component of the third touch fastener is disposed on the supporting surface of the interior longitudinal bar and coupled to the interior longitudinal bar; and
the attaching surface of each supporting bar at a middle portion between the first and second ends is coupled to the second component of the third touch fastener.

19. The bed frame of claim 18, wherein the third touch fastener is a hook-loop fastener, a Velcro® fastener or a Velcro® tape.

20. A bed comprising a bed frame of claim 1.
